(19) United States
(12) Patent Application Publication
(10) Pub. No.: US 2026/0308909 A1
(43) Pub. Date: Oct. 8, 2026

(54) Fire-Resistant Building Panels

(71) Applicant: ENVIROGRAF LTD, Kent (GB)

(72) Inventor: Derek WARD, Dover (GB)

(21) Appl. No.: 19/480,360

(22) PCT Filed: Apr. 24, 2024
(86) PCT No.: PCT/GB2024/051059

§ 371 Date: Oct. 30, 2025

(30) Foreign Application Priority Data
May 24, 2023 (GB) 2307752.2

(51) Int. Cl. E04C 2/296; B32B 13/10; E04B 1/94; E04B 2/00; E04C 2/38; E04C 2/52

(52) U.S. Cl. CPC E04C 2/296; B32B 13/10; E04B 1/947; E04C 2/386; E04C 2/46; E04C 2/521; B32B 2307/3065; B32B 2307/7376; B32B 2607/00

(57) ABSTRACT

A fire-resistant structural building panel which, in use, defines a part of an internal wall of a building and which comprises a rectangular timber frame which borders a quantity of high density thermally insulating material. The frame comprises upper and lower horizontal frame members each coated with a solution including an intumescent material and each connected to generally vertical side frame members also coated with a solution containing an intumescent material. A plurality of sheet members are secured to the frame members and are dimensioned to match the dimensions of the rectangular frame along the horizontal sides and one vertical side of the frame but to extend beyond the other vertical side of the frame to define a channel open to receive an additional vertical frame member of width and depth substantially equal to the width and depth of the channel. Each external panel member comprises a plurality of equally dimensioned sheet members each coated on at least one side with a solution of intumescent material and each adhered to its neighbouring sheet or sheets.

### FIELD OF THE INVENTION

This invention relates to fire-resistant panels for use in the construction of buildings.

More especially the invention concerns fire-resistant structural panels which in use define sections of internal walls for use in the construction of housing and industrial units,

### BACKGROUND TO THE INVENTION

Structural panels for use in the construction of both residential and commercial buildings are commonplace.

Such panels generally include a core of rigid foam insulating material sandwiched between and adhesively bonded or otherwise secured to inner and outer panels of, for example, plasterboard or wood.

Structural panels facilitate inter alia a fast-track building process for residential and commercial buildings with potential cost savings for reason that they are relatively lightweight and simple to erect.

However, currently available structural panels have limited ability to act as fire barriers, their resistance to the spread of smoke and fire being in many cases less than ten minutes.

Our UK Patent 2603273B discloses a fire-resistant structural panel for residential and commercial buildings having enhanced resistance to the spread of smoke and fire and the present invention concerns fire resistant structural panels having improved features to those disclosed in this earlier patent.

More particularly, the present invention sets out to provide fire resistant building panels which have all the advantages of presently available structural panels which define sections of internal partition walls of residential and commercial buildings and which additionally act as effective firebreaks for periods in excess of four hours.

Additionally, fire resistant structural panels in accordance with the invention provide enhanced acoustic protection.

### STATEMENTS OF THE INVENTION

In a preferred aspect, the invention provides a fire-resistant structural building panel which, in use, defines a part of an internal wall of a building, said panel comprising a rectangular frame which borders a quantity of high density thermally insulating material and comprises upper and lower generally horizontal frame members each coated on at least one side with a solution including an intumescent material and each connected to generally vertical side frame members also coated on at least one side with a solution which contains an intumescent material, said building panel further comprising a plurality of equally dimensioned sheet members each coated on at least one side with a solution which includes an intumescent material and each adhered to its neighbouring sheet or sheet members; each sheet member being secured to said frame members and dimensioned to match the dimensions of the rectangular frame along the horizontal sides and one generally vertical side of the frame but to extend beyond the other vertical side of the frame to define a channel open to receive an additional vertical frame member of width and depth substantially equal to the width and depth respectively of the channel; characterised in that the panel includes an internal open-ended channel or conduit which extends downwardly from the upper generally horizontal frame member and is dimensioned to receive cabling connectable to a source of electricity. The channel or conduit may extend along the full height or along part of the height of the panel; and the arrangement being such that, if damaged, one or each outermost sheet member can be removed from the panel and replaced by a fresh sheet member without significant damage to the surface of the underlying panel.

Preferably, each said panel comprises a plurality of equally dimensioned sheet members each coated on at least one side with a solution of intumescent material and adhered to its neighbouring sheet or sheets, whereby if damaged, one or each outermost sheet member of said panel can be removed from the panel and replaced by a fresh sheet member.

Preferably, each panel comprises three or more equally dimensioned sheets each coated on at least one side with a solution including an intumescent material.

A preferred intumescent containing solution is HW01 as supplied by the Applicant.

Each external panel preferably comprises an inner sheet of oriented strand board (OSB) and two sheets of plasterboard.

Typically, the thickness of the panels is between 10 and 12 mm; a preferred thickness is 11 mm.

Each of the other sheets of the panel preferably comprise plasterboard of thickness between 10 mm and 14 mm, preferably 12.5 mm. The total thickness of the panel is preferably between 120 mm and 140 mm, preferably 132 mm.

An additional side frame member may be provided for attachment to said one vertical side frame member for selective location within said channel.

### BRIEF DESCRIPTION OF THE DRAWINGS

The invention will now be described by way of example only with reference to the accompanying drawings in which:

FIG. 1 is a side view of a fire-resistant building panel in accordance with the invention with one external facing sheet removed to show internal features of the panel;

FIG. 2 is an end view from above of the panel shown in FIG. 1 to an enlarged scale;

FIG. 3 is an end view of adjoining end portions of panels in accordance with the invention which together form sections of an internal wall of a building;

FIG. 4 illustrates adjoining end portions of panels in accordance with the invention which together define a corner section of internal walls of a building; and

FIG. 5 is a side view in section to an enlarged scale of a central part of a panel in accordance with the invention.

### DETAILED DESCRIPTION OF THE INVENTION

The structural fire-resistant building panel illustrated in the drawings is intended for use in new and existing buildings to define, in concert with other identical or similar panels, the internal walls and ceilings of rooms and spaces within such buildings.

The illustrated building panel comprises a rectangular timber frame 10 which borders a sheet or sheets 12 of a high density thermally insulating material such as that known as rock-wall insulation. Typically, the thickness of the insulating material is between 30 and 60 mm (preferably 40 mm). The frame 10 comprises upper and lower horizontal elongate timber side members 14a, 14b each coated with a solution which includes an intumescent material, and vertical elongate timber side frame members 16a, 16b also coated with a solution which contains an intumescent material.

A suitable coating is the intumescent coating HW01 supplied by the Applicant.

Typically, the overall dimension of the frame is 1220 mm by 2440 mm.

As will be seen from FIG. 2, the front and rear sides of the panel are covered by panel sheets 18a, 18b each secured to the frame 10 by any conventional means.

In use, the panel sheet 18a is positioned on the external face of the panel and the sheet 18b on the internal face of the panel.

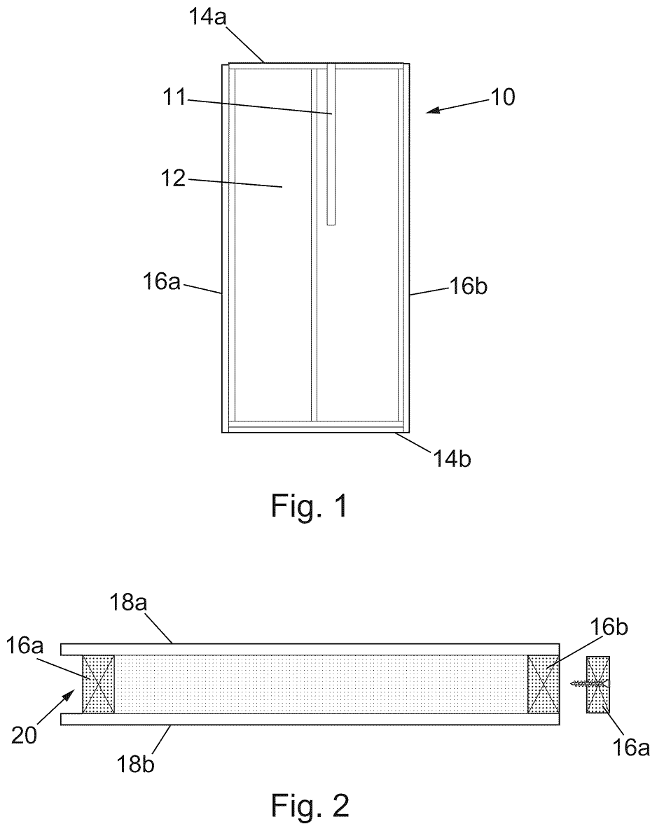

As will be seen from FIG. 1, the panel includes an internal open-ended channel 11 which extends downwardly from the upper end of the frame 10. This channel is dimensioned to receive cabling connected to a source of electricity.

The illustrated panel is essentially for use in ground floors of buildings. For floors above ground level, the channel will preferably extend over the entire height of the panel and communicate with an equivalent channel 11 of a ground floor panel.

As will be seen more clearly from FIG. 2, the side frame member 16a is spaced inwardly from the adjacent side edges of the panel sheets 18a, 18b to define an open sided channel 20 whose length is equal to the length of an additional side member 22 and whose cross section is marginally greater than that of the side member 22 to assist insertion of the side member 22 into the channel 20 when required.

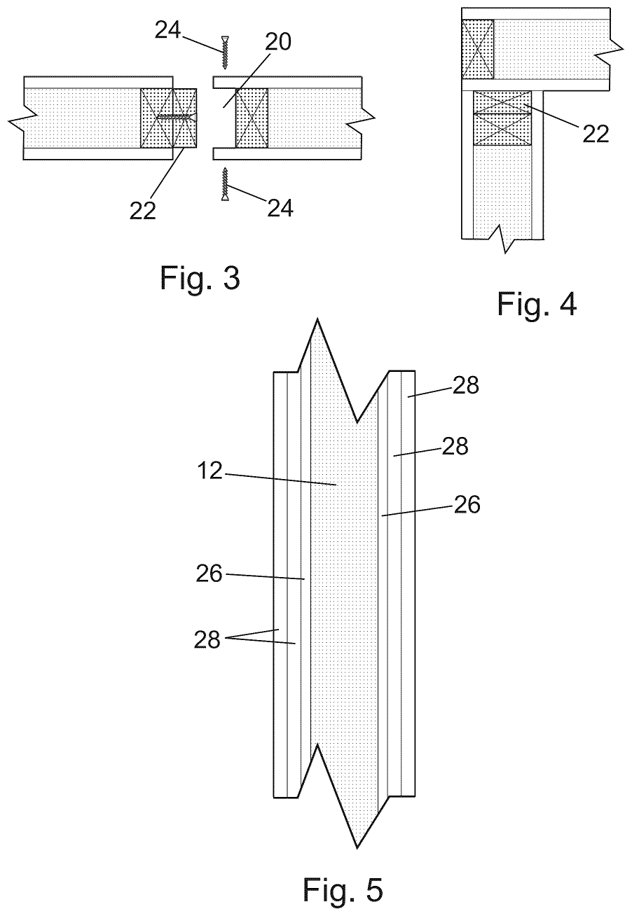

As illustrated in FIG. 3 of the drawings, the side member 22, in use, is attached to the exposed side surface of the frame member 16b to define a lengthwise extending extension which, when required, defines a close fit within the channel 20 of an adjoining panel. In this way the panels can readily be joined one to each other to define an internal wall or ceiling of a building.

Screws 24 are provided to secure the to secure the side member 22 within the channel 20.

As will be seen from FIG. 4, the additional side member 22 can also be positioned within the open side of a panel to close the channel 20 when securing adjoining panels to define a rectangular reinforced corner of a room or space.

Turning now to FIG. 5 of the drawings, each panel sheet 18a, 18b comprises an inner lining comprising an OSB panel 26 and two or more super-imposed cover sheets 28 of, for example, plaster board. The panel 26 and cover sheets 28 are secured one to another by a suitable adhesive which preferably includes an intumescent material.

As will be seen from FIG. 1, the panel 10 includes an internal open-ended channel 11 which extends downwardly from the upper end of the frame 10. This channel is dimensional to receive cabling connected to a source of electricity.

The panel illustrated is essentially for use in ground floors of buildings. For floors above ground level, the channel will extend over the entire height of the panel.

The intumescent content of the described building panels enables the panels to act as fire breaks for periods in excess of four hours, a period of time normally sufficient to locate and extinguish a fire. Once a fire has been extinguished, the exposed sheets 28 of any fire affected panels can be readily removed and if required, replaced with a fresh panel or panels.

It will be appreciated that the foregoing is merely exemplary of fire-resistant panels in accordance with the invention and that modifications can readily be made thereto without departing from the true scope of the invention as set out in the appended claims.

1. A fire-resistant structural building panel which, in use, defines a part of an internal wall of a building, said panel comprising a rectangular frame which borders a quantity of high density thermally insulating material and comprises upper and lower generally horizontal frame members each coated on at least one side with a solution including an intumescent material and each connected to generally vertical side frame members also coated on at least one side with a solution which contains an intumescent material;
said building panel further comprising a plurality of equally dimensioned sheet members each coated on at least one side with a solution which includes an intumescent material and each adhered to its neighbouring sheet or sheet members;
each sheet member being secured to said frame members and dimensioned to match the dimensions of the rectangular frame along the horizontal sides and one generally vertical side of the frame but to extend beyond the other vertical side of the frame to define a channel open to receive an additional vertical frame member of width and depth substantially equal to the width and depth respectively of the channel;
said building panel further including an internal open-ended conduit which extends downwardly from the upper generally horizontal frame member and is dimensioned to receive cabling connectable to an electricity supply: and
the arrangement being such that, if damaged, one or each outermost sheet member can be removed from the panel and replaced by a fresh sheet member without significant damage to the surface of the underlying panel.

2. A building panel as claimed in claim 1 wherein each sheet member comprises an inner sheet of oriented strand board (OSB) and at least two sheets of plasterboard.

3. A building panel as claimed in claim 1, wherein the thickness of each sheet member is between 10 and 12 mm.

4. (canceled)

5. A building panel as claimed in claim 1, wherein said channel or conduit extends along the full height of the panel.

6. A building panel as claimed in claim 1, wherein an additional side frame member is provided for attachment to one said vertical side frame member for selective location within said channel.
